(19) United States
(12) Patent Application Publication
(10) Pub. No.: US 2024/0367099 A1
(43) Pub. Date: Nov. 7, 2024

(54) TREATMENT SYSTEM AND TREATMENT METHOD FOR REMEDIATING CONTAMINANTS, INCLUDING CARBON BASED CONTAMINANTS, IN GASSES

(71) Applicant: GAPS Technology, LLC, SLIDELL, LA (US)

(72) Inventor: Cliffton L. ROE, HARRISON TOWNSHIP, MI (US)

(21) Appl. No.: 18/652,548

(22) Filed: May 1, 2024

Related U.S. Application Data
(60) Provisional application No. 63/463,155, filed on May 1, 2023.

(51) Int. Cl. B01D 53/62; B01D 53/92

(52) U.S. Cl. CPC B01D 53/62; B01D 53/92; B01D 2257/504; B01D 2258/01; B01D 2259/122; B01D 2259/814

(57) ABSTRACT

A treatment process for removing and/or remediating contaminants in a contaminated gas, includes generating vapor containing hydroxide ions, mixing the vapor containing hydroxide ions with a gas containing carbon dioxide (CO₂), and allowing the mixture of the vapor containing hydroxide ions and the gas to react. The step of generating vapor containing hydroxide ions involves boiling an aqueous solution containing ammonium hydroxide. The aqueous solution containing ammonium hydroxide can be enhanced to a higher hydroxide concentration and a higher pH by dissolving at least one other hydroxide compound in the aqueous solution.

### CROSS-REFERENCE TO RELATED APPLICATIONS

This application claims priority to U.S. Provisional Application Ser. No. 63/463,155, filed May 1, 2023. The entire subject matter of this priority application is incorporated by reference herein.

### BACKGROUND OF THE INVENTION

### 1. Field of the Invention

The present disclosure relates to a treatment system and treatment method for remediating contaminants, including carbon based contaminants, in various gasses, including combustion gasses from natural gas and other hydrocarbon based fuels, gasses produced in the generation of cement, etc. More particularly, the present disclosure relates to such a treatment system and treatment method in which the contaminants, including carbon dioxide (CO₂), in the various gasses are efficiently and significantly reduced and/or removed in an economically practical manner.

### 2. Background

Hydrocarbon based fuels have been a main fuel used by the world for over 150 years because of their availability, ease of use and effectiveness. However, much of the world is now concerned about use of hydrocarbon based fuels because they generate a significant amount of undesired emissions typically in the form of gasses, including carbon monoxide (CO), carbon dioxide (CO₂), nitrogen based oxides (NOₓ), sulfur based oxides (SOₓ), etc., some of which are toxic or harmful to humans and others of which are not specifically toxic or harmful to humans but can cause other problems like smog as they accumulate in various layers of the earth's atmosphere, etc. Often such emissions may be treated and/or removed, particularly the emissions which are toxic or harmful to humans, but the treatment and removal come with added expense.

Also, it has not been practical or possible to treat or remove some of the emissions, such as CO₂, because they are so prevalent whereby these emission gasses are typically released directly into the earth's atmosphere with little or no treatment. For example, natural gas is an extremely common hydrocarbon based fuel and vast amounts of natural are combusted in the United States everyday for heating, cooking, in internal combustion engines, etc., and although natural gas primarily releases water and carbon dioxide when it is combusted, little or no efforts are made to treat or capture the CO₂, so it is released into the atmosphere. Further, while most of the natural gas being combusted has very low levels of contaminants so that it burns fairly clean, e.g., primarily only water and carbon dioxide are generated, some natural gas containing significantly higher levels of contaminants, e.g., natural gas directly from the earth, is also regularly combusted or flared and the exhaust emissions from such contaminated natural gas are often directly released into the atmosphere as well.

There is particular concern in the world regarding so called green house gasses, primary of which is CO₂, because of effects these gasses may be having on the earth's climate, and some governments around the world pay out billions of dollars every year in carbon credits toward the purpose of reducing the amount of green house gasses being released by various industries. Sometimes such reduction is more of a shift than an actual reduction of total amount of CO₂ being released into the atmosphere. For example, the US Government gives carbon credits for electric vehicles which exclusively use electricity to drive motors that move the vehicles, and hence do not directly output exhaust emissions from hydrocarbon fuels, but often the electricity used by the electric vehicles is generated through combustion of hydrocarbon based fuels in power plants that generate the electricity. Such power plants will typically have exhaust scrubbers and the like to remove many of the metals and solid contaminants from the exhaust emissions from the combusted hydrocarbon based fuels, but much of the CO₂ in the exhaust emissions is still released into the atmosphere.

There are known treatment systems and treatment methods for removing CO₂ and other contaminants in the various gasses, including combustion gasses from hydrocarbon based fuels, and typically involve contacting or reacting the combustion gasses with various aqueous liquid treatment solutions. For example, many of the known treatment systems and treatment methods involve a process known as the Solvay process or variations thereof. Solvay is a process for the manufacture of sodium carbonate (soda ash), where ammonia and carbon dioxide are passed through a saturated sodium chloride solution, e.g., the ammonia and combustion gasses are passed/bubbled up through a quantity of the aqueous solution contained in a reaction tower or column, to form soluble ammonium chloride and a precipitate of sodium bicarbonate according to Reaction (1) below. The sodium bicarbonate has commercial value, e.g., it may be heated to form the washing soda, and the ammonium chloride solution may be reacted with calcium hydroxide to recover the ammonia according to the Reactions (2) and (3), respectively, below. Also, if seawater is used as sodium chloride solution, this process also reduces the amount of salt in the seawater based on the Reaction (1).

NaCl+NH₃+CO₂+H₂O→NaHCO₃+NH₄Cl (1)

2NaHCO₃→Na₂CO₃+CO₂+H₂O (2)

2NH₄Cl+Ca(OH)₂→CaCl₂+2NH₃+2H₂O (3).

JP 5268719 B2 discloses a treatment process similar to the Solvay process which involves contacting the exhaust gasses with a saturated sodium chloride solution into which ammonia (NH₃) gas has been dissolved. The combustion gasses containing CO₂ are contacted with the aqueous solution such that the CO₂ is absorbed by and/or reacts with the aqueous solution to generate sodium hydrogen carbonate/sodium bicarbonate (NaHCO₃) and a solution containing ammonium chloride. See JP 5268719 B2.

U.S. Pat. No. 10,118,843 B2 discloses another process for the removal of CO₂ from various gasses which uses an aqueous solution containing sodium chloride together with calcium oxide and/or calcium hydroxide at a collective concentration of at least 0.5% wt. This process avoids the use of ammonia, which is a toxic gas and requires special handling. In this process, the combustion gasses also are passed/bubbled up through a quantity of the aqueous solution contained in a reaction tower or column to form sodium bicarbonate which precipitates from the aqueous solution and may be collected and removed.

Unfortunately, the known treatment systems and treatment methods for removing contaminants, including CO₂ from various gasses, including hydrocarbon fuel combustion gasses, are not particularly efficient or cost effective and correspondingly are not widely used. Hence, there remains a great need in the art for a treatment system and process which can efficiently remove contaminants, including carbon based contaminants, in combustion gasses from hydrocarbon based fuels in a practical, cost effective manner.

### DISCLOSURE OF THE INVENTION

An object of the present invention is to satisfy the discussed need in the art.

The present inventor has studied at length the treatment of various gasses, including combustion gasses from hydrocarbon based fuels, and has discovered new treatment systems and treatment processes which are far more effective, efficient and economically practical than the conventionally known treatment systems and processes for remediating and/or removing essentially all types of contaminants, including carbon dioxide, in combustion gasses and other gasses down to significantly reduced levels in a very efficient and cost effective manner.

A first discovery made by the present inventor for treatment of the various gasses to remediate or remove CO₂ and other undesirable contaminants, including carbon monoxide (CO), carbon dioxide (CO₂), nitrogen based oxides (NOₓ), sulfur based oxides (SOₓ), is that the conventionally known treatment systems and processes are particularly inefficient because they use aqueous liquid solutions for treating the gasses, e.g., the gasses are passed/bubbled up through a quantity of the aqueous solution contained in a reaction tower or column. The inventor has determined that the liquid-gas interaction in such systems and processes is inherently inefficient for a number of reasons, e.g., there is limited amount of contact between the chemical reactants in the liquid aqueous solutions and gaseous contaminants in the contaminated gasses as the gasses bubble up through the aqueous solutions, so that it is particularly challenging to efficiently remove contaminants from the gasses based on liquid to gas reactions.

Previously, the present inventor has discovered that hydroxide compounds, e.g., sodium hydroxide (NaOH) and potassium hydroxide (KOH), may be added to aqueous water wash solutions for removing various contaminants, including hydrogen sulfide (H₂S) and CO₂, from various gasses, including natural gas and combustion gasses from hydrocarbon based fuels, e.g., see US Patent Pub. 2022/0411701 A1. In comparison to the Solvay process and the other conventionally known processes used to remove CO₂ in gasses, including combustion gasses from hydrocarbon based fuels, the inventor's previously proposed treatment processes involving hydroxide containing water wash solutions are significantly more effective and cost efficient for removing contaminants such as H₂S and CO₂ from such gasses, but the treatment processes involving the water wash solutions still have inefficiencies based on the liquid-gas interactions in such processes.

The present inventor has further studied this, and has now discovered that it is possible to efficiently generate large volumes of hydroxide containing vapors that can be combined with various gasses for remediating the gasses or components of the gasses. For example, the hydroxide containing vapors generated according to the invention can be combined with the combustion gasses from hydrocarbon based fuels, to achieve a more efficient and cost effective remediation and/or removal of some of the undesirable gasses, including CO, CO₂, NOₓ and SOₓ, in the combustion gasses because this involves vapor to vapor contact between the undesirable gasses and the hydroxide vapors. Particularly, the inventor has discovered that it is possible to efficiently generate large volumes of hydroxide containing vapors using an ammonium hydroxide (NH₄OH) solution prepared by dissolving ammonia (NH₃) in water. Solutions of ammonium hydroxide come in different concentrations, but a saturated solution of ammonium hydroxide may contain about 25% to 28% wt ammonia and boils at about 98° F. The present inventor has found that by boiling a saturated solution of ammonium hydroxide, the vapors that are released from the boiling solution contain hydroxide and when these vapors are added to the various gasses, e.g., a stream of the hydroxide vapors is added into a flowing stream hydrocarbon combustion gasses, the hydroxide containing vapors quickly and intimately mix into the gasses and quickly remediate the levels of many of the contaminants in the gasses, including CO, CO₂, NOₓ and SOₓ, down to very low levels, e.g., down to one part per million or less. The CO₂ in the combustion gasses reacts with the hydroxide in the vapors and form ammonium bicarbonate particles, which drop out of the gaseous mixture and can be separated, removed and ultimately sold commercially. Reactions of CO₂ with ammonium hydroxide are as follows:

NH₃+H₂O→NH₄OH

CO₂+H₂O→H₂CO₃

NH₄OH+H₂CO₃→NH₄CO₃+H₂O

The inventor has determined that one liter of a saturated solution of ammonium hydroxide can generate a much larger volume of the hydroxide containing vapors, e.g., up to eighty two (82) ft³ of the vapors, although as the ammonium hydroxide solution boils it will contain less and less ammonium hydroxide and the amount of hydroxide in the vapors will be correspondingly reduced. Again, the hydroxide vapors may be easily and quickly combined with the gasses being treated, and because of the gaseous nature of the hydroxide vapors there is much greater contact achieved between the hydroxide in the vapors and the contaminants in the gasses than is possible by bubbling the contaminated gasses through a relatively large amount of a treatment liquid contained in a tower or column as is done in the conventionally known processes. The difference between vapor to vapor contact and liquid to vapor contact for these reactions is very significant. For example, a given amount of combustion gasses from hydrocarbon based fuels can be more efficiently remediated using comparatively small amount of the saturated aqueous solution of ammonium hydroxide, which is boiled an turned into hydroxide containing vapors, as compared to the conventionally known treatment processes which rely on liquid to vapor contact involving a relatively large amount of a treatment liquid disposed in a reactor tower or column. The conventional processes for removing CO₂ involving liquid to vapor contact, such as the Solvay process, may remove the CO₂ at a rate of about 1 mole of key reactant, e.g., ammonia, per mole of CO₂ that is removed. However, in experiments conducted by the present inventor using this new treatment process involving hydroxide containing vapors from a boiled ammonium hydroxide solution he has achieved CO₂ removal rates of up to fifteen (15) moles of CO₂ per mole of the ammonium hydroxide solution.

While there are many other hydroxide compounds besides ammonium hydroxide, e.g. sodium hydroxide (NaOH) and potassium hydroxide (KOH) are two hydroxides used very extensively everyday in many different commercial processes, ammonium hydroxide is uniquely different from these other hydroxide compounds based on its relatively low boiling point and because it is generated specifically as an aqueous solution using ammonia and water in which the water itself becomes the source of the hydroxide ion. Other hydroxides such as sodium hydroxide and potassium hydroxide come in solid forms containing little or no water at standard temperature and pressure (STP), as well as in an aqueous solutions in various concentrations. Also, these other hydroxide compounds are much stronger bases than ammonium hydroxide and have much higher pKa values than does ammonium hydroxide. However, aqueous solutions of these other hydroxide compounds boil at temperatures much higher than 100° F., such that it would require much more heat and energy to generate hydroxide vapors using these other hydroxide compounds in comparison to ammonium hydroxide.

An experiment conducted by the inventor provided the following results. In this experiment a saturated solution of ammonium hydroxide was prepared by dissolving ammonia (NH₃) in water at a concentration of about 28 wt % ammonia and this was boiled at about 100° F. or 37.8° C. to generate ammonium hydroxide vapors. The inventor has determined that for treating pure (100%) CO₂ gas with the ammonium hydroxide vapors according to the present invention, an appropriate dosage rate is 1 ml of the saturated solution of ammonium hydroxide which when boiled produces a sufficient amount of ammonium hydroxide vapors to treat one liter of pure (100%) CO₂. Expanding this out to larger volumes, one US gallon of the saturated ammonium hydroxide solution can produce sufficient ammonium hydroxide vapors to treat about 3,220 ft³ or 91200 liters of pure CO₂ gas, or to treat about 53,660 ft³ of a gas mixture containing 6% CO₂ gas. Further expanding, twenty US gallons of the saturated ammonium hydroxide solution can produce sufficient ammonium hydroxide vapors to treat about 1,072,000 ft³ of a gas mixture containing 6% CO₂ gas, which is the equivalent of 5000 lbs or 2.5 tons of CO₂. The reaction of ammonium hydroxide and CO₂ produces ammonium bicarbonate NH₄CO₃ and water. The ammonium bicarbonate can be recovered and sold commercially.

In summary treatment of CO₂ using a saturated solution of ammonium hydroxide was prepared by dissolving ammonia (NH₃) in water at a concentration of about 28 wt % ammonia and boiled at about 100° F. or 37.8° C. to generate ammonium hydroxide vapors, is as follows:
1 cubic ft=28,316 liters
Use 1 liter/hr @ 1,000,000 ppm of CO₂ (pure CO₂ gas)
1/16 of 100 milliliters
Dosing rate: ease of use 1 ml/24 liters of pure CO₂
   So everyday 24 liters of gas is mitigated by 1 ml of the saturated ammonium hydroxide solution, And 1 gallon of saturated ammonium hydroxide (NH₄OH) solution mitigates about 91200 liters or 3.22 MCF (1000 ft³) CO₂ @ 1,000,000 ppm (pure CO₂ gas).
1 gallon=53.66 MCF @ 60,000 ppm (6 vol % CO₂ gas)
10 gallons=536.6 MCF @ 60,000 ppm (6 vol % CO₂ gas)
20 gallons=1,072 MCF @ 60,000 ppm (6 vol % CO₂ gas)
5,000 lbs CO₂ (2.5 tons)
1,000,000 ft³ containing 1 vol % CO₂ (10,000 ppm)=1301 lbs of CO₂
Currently Ammonium Hydroxide solution costs about $1.45/gallon
1 gallon of saturated ammonium hydroxide solution remediates—17.4 lbs CO₂
   Which equates to $0.08 cents/LBS of CO₂ cost, excluding the value of the ammonium bicarbonate produced and recovered.

Another discovery by the inventor, is that it is possible to enhance an ammonium hydroxide aqueous solution such that it becomes a stronger base with higher pKa and can generate more hydroxide vapors by adding one or more other hydroxide compounds to the ammonium hydroxide solution, and that the enhanced ammonium hydroxide solution can still be readily boiled at relatively low temperatures to generate hydroxide containing vapors for use in treating various gasses such as the combustion gasses from hydrocarbon based fuels. For example, a quantity of one or more other hydroxide compound(s), such as sodium hydroxide and potassium hydroxide, in solid form may be dissolved into the ammonium hydroxide solution, or a quantity of an aqueous solution of such hydroxide compound(s) may be combined with the ammonium hydroxide solution. Also, a chelating agent such as ethylenediaminetetraacetic acid (EDTA) may be added in a small amount, e.g., 0.1 to 2.0 wt %, to help dissociate the hydroxide compound(s) other than ammonium hydroxide. This can result in precipitation of salts from the aqueous solution, while the OH⁻ radicals from the other hydroxide compound(s) enhance the aqueous solution. Generally, all hydroxide compounds may be used provided they can be dissolved or dispersed in the aqueous ammonium hydroxide solution. Some typical hydroxide compounds that may be used in the new treatment compositions include sodium hydroxide (NaOH), potassium hydroxide (KOH), lithium hydroxide (LiOH), magnesium hydroxide (Mg(OH)₂), and manganese hydroxide (Mn(OH)₂, Mn(OH)₄). However, NaOH and KOH have lower cost than the other hydroxides and if used may make the composition and treatment processes using the composition more economically advantageous. A saturated solution of ammonium hydroxide that has been enhanced with sodium hydroxide and/or potassium hydroxide will produce vapors of these other hydroxides as well as vapors of the ammonium hydroxide, all of which will react with CO₂ and other gasses, such as those contained in the combustion gasses of hydrocarbon based fuels. The reactions of CO₂ with sodium hydroxide and potassium hydroxide are as follows.

2NaOH(s)+CO₂(g)→Na₂CO₃(aq)+H₂O(l);

2KOH+CO₂→K₂CO₃(aq)+H₂O(l).

In an experiment, the inventor combined a saturated aqueous ammonium hydroxide solution containing about 25 wt % ammonia and an aqueous solution containing 45 wt % potassium hydroxide at a ratio of 3:1 ammonium hydroxide solution to potassium hydroxide solution. With this mixture the pH increased to 14.77 from a pH of 10.65 for the saturated solution of ammonium hydroxide. The combined solution boiled at about 112-115° F. and generated hydroxide containing vapors similar to boiling a saturated solution of just ammonium hydroxide. However, the amount of hydroxide ions in the vapor from the combined solution was significantly greater than the amount of hydroxide ions generated by boiling the saturated ammonium hydroxide solution. The hydroxide vapors generated in this manner were used to treat gasses generated by combusting natural gas, i.e., by combining/mixing the hydroxide vapors with the combustion gasses from natural gas. Initially, the combustion gasses contained about 10% volume CO₂, but treatment with the hydroxide vapors according to the present invention reduced the CO₂ content in the combustion gasses to less than 5 ppm. Correspondingly, in the inventor's new vapor to vapor treatment process a given amount of the combined hydroxide solutions was effective for remediating contaminants in a greater volume of the combustion gasses from hydrocarbon based fuels, including CO₂, in comparison to using the same given amount of saturated ammonium hydroxide solution.

The inventor has also determined that when treating the combustion gasses from hydrocarbon based fuels using his new vapor to vapor treatment process in a continuous manner, e.g., hydroxide containing vapors from a boiled mixed hydroxide solution or a saturated ammonium hydroxide solution are introduced into a pipeline through which the combustion gasses from hydrocarbon based fuels are flowing, it is possible to control and adjust the amount of hydroxide containing vapor being generated and introduced into the pipeline based on the temperature at which the solution is boiled. For example, while a saturated ammonium hydroxide solution may boil at 98° F. and a 3:1 mixed solution of ammonium hydroxide and potassium hydroxide may boil at 112-115° F., the temperatures to which these solutions are heated may be increased above these minimum boiling points. Further, the particular formulation of a mixed hydroxide solution may be adjusted by adding more or less of other hydroxide(s) to the saturated ammonium hydroxide solution to raise or lower the boiling point of the mixed solution. The amount of hydroxide containing vapors may be adjusted based on the levels of contaminants, including CO₂, in the combustion gasses and/or according to a desired level of remediation of the contaminants in the combustion gasses.

According to another discovery by the present inventor, it is possible to separate or isolate various contaminants in the combustion gasses from hydrocarbon based fuels based on magnetism, which can be advantageous if there is interest in primarily remediating only select contaminants in the combustion gasses, such as CO₂ for which governments give carbon credits. Through research and experimentation the inventor has discovered that CO₂ is a stable diamagnetic molecule with paired electrons and that when CO₂ is exposed to a magnet the CO₂ will be repelled away from the magnet. On the other hand, the inventor has discovered that NOₓ, which is a large component of the combustion gasses from hydrocarbon based fuels, is less stable than CO₂ because it is paramagnetic and will be attracted by a magnet. Thus, if there is interest in primarily remediating CO₂ in the combustion gasses from hydrocarbon based fuels, the inventor's new vapor to vapor treatment process can be made more efficient and cost effective by isolating the CO₂ and/or removing the NOₓ from the combustion gasses and then treating only the CO₂ which has been isolated or treating the combustion gasses from which the NOₓ has been removed. This reduces cost of the treatment process not only because it is possible to treat a much smaller volume of the combustion gas is being treated, and also because none of the hydroxide containing vapor is used to remediate the NOₓ. Thus, for example, a flowpath for the combustion gasses from hydrocarbon based fuels may be fitted with magnet(s) and/or electromagnet(s) such that one fraction of the exhaust gas containing a larger proportion of CO₂ may be directed by the magnet(s) to flow into one secondary flowpath and another fraction of the exhaust gas containing a smaller proportion of CO₂ may be directed by the magnet(s) to flow into another secondary flowpath, and only the fraction of the exhaust gas containing the larger proportion of CO₂ may be treated using hydroxide containing vapors according the inventor's new treatment process.

The foregoing description is given for clearness of understanding only, and no unnecessary limitations should be understood therefrom, as modifications within the scope of the invention may be apparent to those having ordinary skill in the art and are encompassed by the claims appended hereto.

I claim:

1. A treatment process for removing and/or remediating contaminants in a contaminated gas, comprising steps of:
generating vapor containing hydroxide ions;
mixing the vapor containing hydroxide ions with a gas containing carbon dioxide (CO₂); and
allowing the mixture of the vapor containing hydroxide ions and the gas to react.

2. The treatment process according to claim 1, wherein the step of generating vapor containing hydroxide ions involves boiling an aqueous solution containing ammonium hydroxide.

3. The treatment process according to claim 2, wherein the aqueous solution containing ammonium hydroxide also contains at least one other hydroxide compound.

4. The treatment process according to claim 1, including a further step of pre-treating the gas to separate a portion of the exhaust gas containing a larger proportion of the carbon dioxide from another portion of the exhaust gas containing a smaller proportion of the carbon dioxide; and
the mixing step involves mixing the vapor containing hydroxide ions with exhaust gas with the separated portion of the exhaust gas containing a larger proportion of carbon dioxide.

5. The treatment process according to claim 4, wherein the pre-treatment step involves subjecting the gas to a magnetic field.

6. The treatment process according to claim 1, wherein the gas is exhaust gas generated by combustion of a hydrocarbon based fuel.
